(19) United States
(12) Patent Application Publication
(10) Pub. No.: US 2020/0108668 A1
(43) Pub. Date: Apr. 9, 2020

(54) TIRE LONGEVITY MEASUREMENT SYSTEM AND METHOD

(71) Applicant: Saar Wein, Henderson, NV (US)

(72) Inventor: Saar Wein, Henderson, NV (US)

(21) Appl. No.: 16/595,075

(22) Filed: Oct. 7, 2019

Related U.S. Application Data
(60) Provisional application No. 62/742,416, filed on Oct. 7, 2018.

(51) Int. Cl. B60C 11/24

(52) U.S. Cl. CPC B60C 11/24

(57) ABSTRACT

A tire wear indication system designed to visually-represent wear and tear on vehicle tires. The system maximizes safety for vehicle owners, effectively ensuring tires can be properly interchanged after a specific amount of wear. It features a series of layers that can measure the life left in each tire, identified via a color and/or shape system. The system allows users to apply different shapes such as stars, pyramids, cylinders, and the like, in order to customize the identification. As designed, the system offers a way for vehicle owners to identify the status of their tires by simply looking at the color-coded and shape system rather than meticulously inspecting each tire.

### CROSS-REFERENCE TO RELATED APPLICATION(S)

The present application is related to and claims priority to U.S. Provisional Patent Application No. 62/742,416 filed Oct. 7, 2018, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of resilient tires and wheels of existing art and more specifically relates to resilient tires and wheels with wear indicating feature.

### RELATED ART

Many individuals drive vehicles in modern society. Most of the vehicles have tires that wear out after a duration of use. Identifying relative wear and tear on tires can be difficult. People may be unable to identify when their tires need to be changed on a car, van, truck, motorcycle, etc. If a vehicle is operated with bald tires, serious accidents and injuries can occur. A suitable solution is desired.

U.S. Pat. No. 5,303,756 to James L. Hill relates to a tire for indicating tread wear and method of manufacturing the same. The described tire for indicating tread wear includes a belted tire including carcass, which is formed by a plurality of body plies, and tread rubber vulcanized to the plies. A plurality of circumferentially spaced apart wear indicating members are secured to the tire carcass, preferably between two plies, but optionally to any single ply. The wear indicating members extend radially outward from the carcass to a desired wear-indicating position, which may be beyond the base of adjacent tire grooves or at other radial levels. The wear indicating member includes a housing assembly containing a visually distinctive material which is visually perceptible from the color of the tire tread. The housing assembly thermally insulates the visually distinctive material sufficiently during vulcanization of the tire to prevent thermal degradation of the wear-indicating material. Optionally, the housings can be solid metallic pins which also provide a shiny visually perceptible wear-indicating material. As the tread rubber wears down, the visually distinctive wear-indicating material is exposed.

### SUMMARY OF THE INVENTION

In view of the foregoing disadvantages inherent in the known resilient tires and wheels with wear indicating feature art, the present disclosure provides a novel tire longevity measurement system. The general purpose of the present disclosure, which will be described subsequently in greater detail, is to provide a safe, effective, and efficient tire longevity measurement system.

A tire longevity measurement system is disclosed. The system comprises a plurality of layered, different-colored, visual-wear-indicators. In some embodiments the indicators include at least a first-color-layer; a second-color-layer; a third-color-layer; and in preferred embodiments a fourth-color-layer; wherein the first-color-layer, the second-color-layer, the third-color-layer; and the fourth-color-layer (when used) are adapted to lie on or within a vehicle tire to sequentially appear as the tire wears. More or fewer layers may be used and various colors and shapes may be used to indicate a desired wear level or warning. The indication of wear may also come from the shape. As wear increases the shape changes and they begin to disappear.

A method of use for the tire longevity measurement system is also disclosed. The method comprising the steps of providing the tire longevity measurement system and manufacturing the vehicle tires to include the tire longevity measurement system.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a tire longevity measurement system, constructed and operative according to the teachings of the present disclosure.

FIG. 1 is a perspective view of the tire longevity measurement system, according to an embodiment of the disclosure.

FIG. 2 is a perspective view of the tire longevity measurement system of FIG. 1, according to an embodiment of the present disclosure.

FIG. 3 is a perspective view of the tire longevity measurement system of FIG. 1, according to an embodiment of the present disclosure.

FIG. 4 is a perspective view of the tire longevity measurement system of FIG. 1, according to an embodiment of the present disclosure.

FIG. 5 is a flow diagram of a method of use for the tire longevity measurement system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to resilient tires and wheels with wear indicating feature and more particularly to a tire longevity measurement system as used to improve the efficiency in visually analyzing relative tire wear.

Generally, Tire Longevity Measure is a color-coded and/or shape identification for tire wear and tear. The indication of wear may also come from the shape. As wear increases the shape changes and they begin to disappear. The system can include an indicator along the channel of tire treads. Shapes may also be applied in order to function as an easily-identifiable method of determining wear for a vehicle tire. The system can feature multiple layers that can measure the useful lifetime left in the tire. Each layer can feature a different color for measuring longevity. The shape design can be included for additional identification. The shapes may be comprised of pyramids, stars, letters, cylinders, and more. The indicator may be applied and used with the tire via colored stickers, painting, chemical reactions, temperature changing powders, chocks, and/or injection molding. Tire Longevity Measure is intended to improve vehicle safety. Exact size, measurement, construction, and design specifications may vary upon manufacturing.

The Longevity Measure may be used as visual only indicators. For example, by creating two different shapes and using them as a tread (two different shapes for 50 k tire for example), each one of them may disappear after 25 k miles, such that as long as a top of the shape (football shape on this example) can be seen it is known that the 50 k tire has 25 k+left (leave the tire with more than 50%<of longevity). Further, when only a portion of a bottom shape (round on this example) is left, we know that the tire has only portion of the 50%>of longevity. In some embodiments, more shapes may be used for a tread (3 different shapes for 50 k tire) and a very bottom shape may include indicia such as “highly recommended for replacement” or “ASAP replacement level”.

Any shape, letter, logo, or number can be used as a pattern. More example of patterns may include: pentagon, cone, sphere, oval, pentagon, octagon, hexagon, rectangular square, cube, round, kite, heart, diamond, letters (ABC), numbers, emoji, or any visual portrait such as a car, face, cat, basketball logo etc.

The Longevity Measure may also be used in a different way to use shapes as visual indicators. By designing and combining a few treads, a shape that can be easily spotted may be created. For example, treads that may wear out after 90% of tire use (or any other percentage). In this embodiment, as an example, when a tire shows a star in a zone of first 90%, it means the tire is in good condition. When the star has disappeared completely it may alert that the tire is in “Highly recommended replacement mode”.

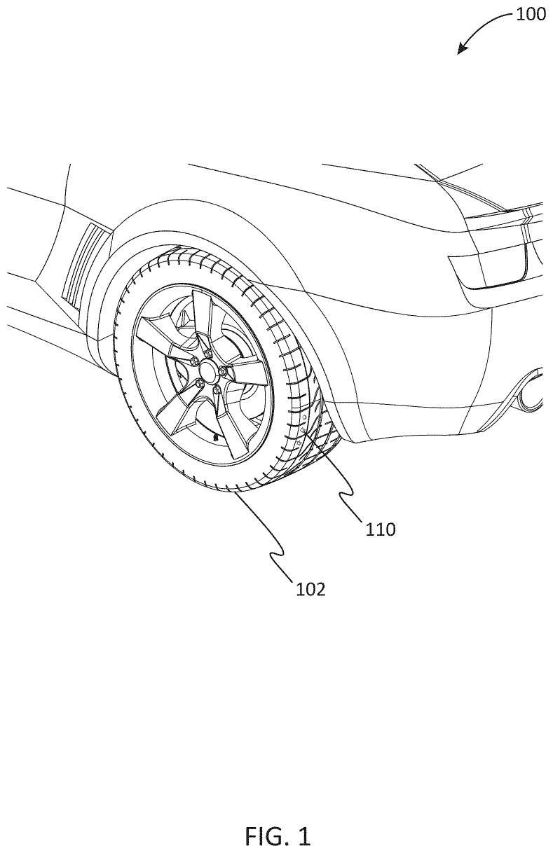

Referring now more specifically to the drawings by numerals of reference, there is shown in FIGS. 1-4, various views of a tire longevity measurement system 100.

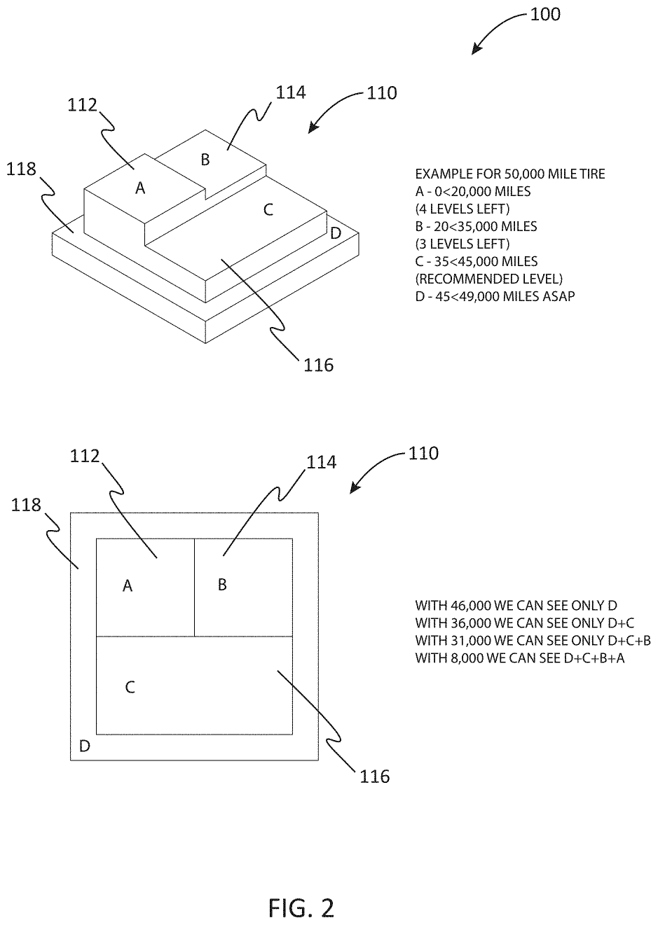

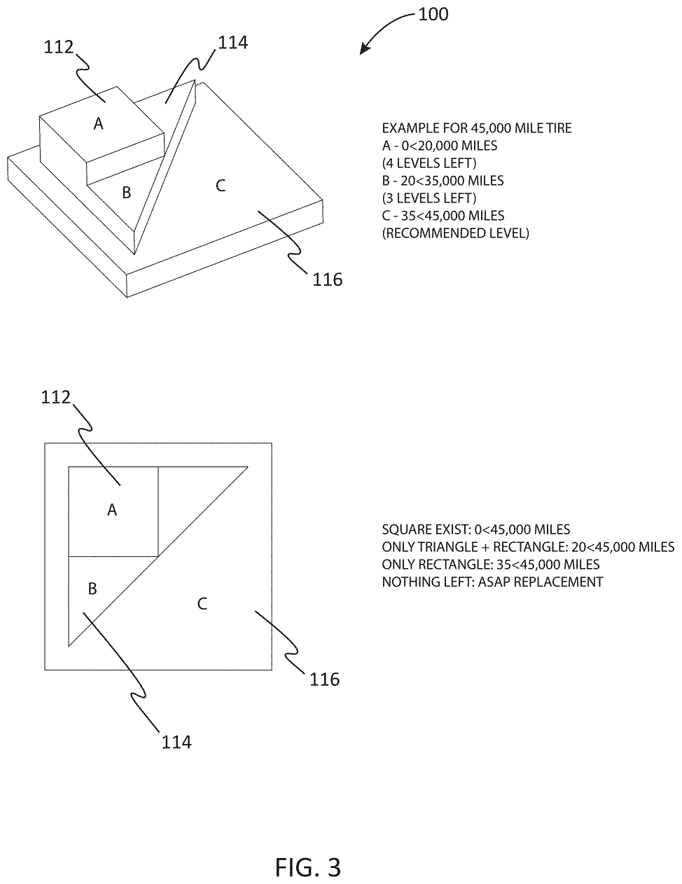

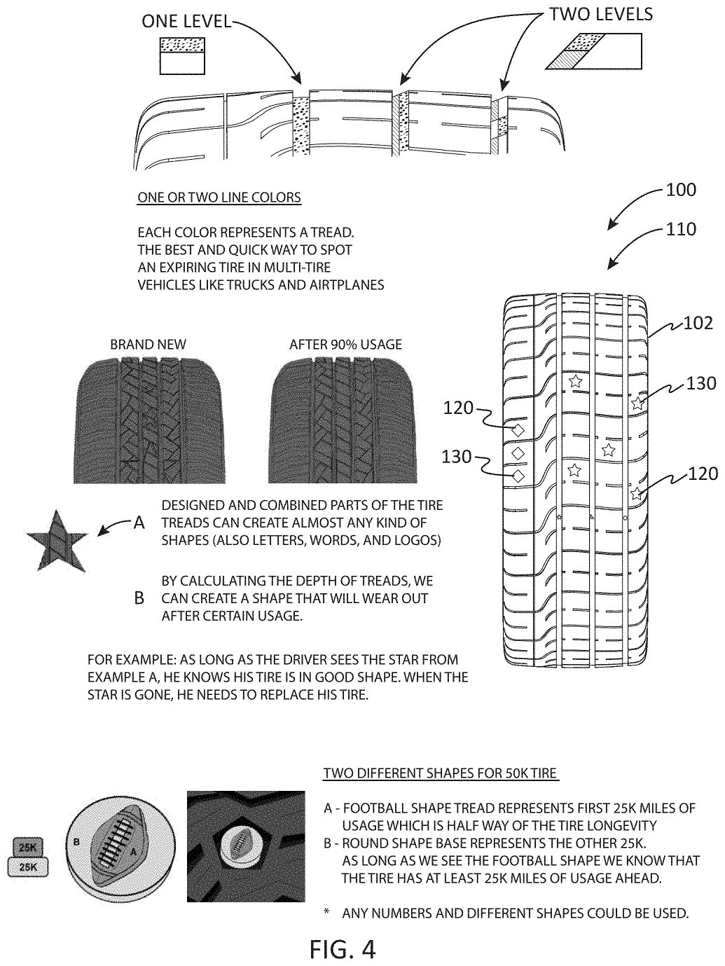

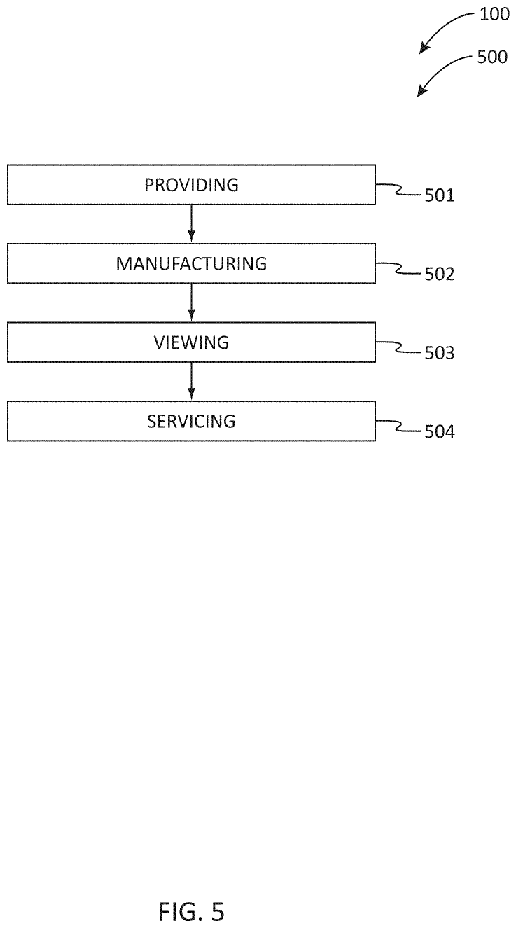

FIG. 1 shows a tire longevity measurement system 100 (how to use the system 100 to measure tire longevity) according to an embodiment of the present disclosure. Here, the tire longevity measurement system 100 may be beneficial for use by a user to readily visually determine relative wear of tires. FIG. 2 shows layers which represent mileage usage left on a tire. FIG. 3 shows layers which represent mileage usage left on a tire with different shapes; FIG. 4 shows color lines integrated into channels. It also shows a combination of treads on a tire to create one visual shape; and FIG. 5 shows an alternate use of the system.

As illustrated in FIGS. 1-4, the tire longevity measurement system 100 may include a plurality of visual-wear-indicators 110 including a first-color-layer 112; a second-color-layer 114; a third-color-layer 116; and in preferred embodiments a fourth-color-layer 118; wherein the first-color-layer 112, the second-color-layer 114, the third-color-layer 116; and the fourth-color-layer 118 are stack-affixed to a vehicle tire 102 such that wear in respective sequence when viewing the rubber vehicle tire 102 provides a viewer-user with a ready indication means of relative tire tread wear. In some versions, the vehicle tire 102 comprises rubber. Colors are differentiated.

The first-color-layer 112, the second-color-layer 114, the third-color-layer 116; and the fourth-color-layer 118 may be stack-affixed to the vehicle tire 102 and are circumferentially-located and in alternate embodiments the color-layers (112, 114, 116, and 118) may be stack-affixed (sequentially) into a ply of the vehicle tire 102 or not into a ply of the vehicle tire 102. In preferred embodiments none of the first-color-layer 112, the second-color-layer 114, the third-color-layer 116; and the fourth-color-layer 118 comprise black pigment such that they can be readily contrasted against the black color of the tire 102. Those with ordinary skill in the art will now appreciate that upon reading this specification and by their understanding the art of tire manufacturing as described herein, methods of affixing will be understood by those knowledgeable in such art.

In certain embodiments of the tire longevity measurement system 100 the first-color-layer 112, the second-color-layer 114, the third-color-layer 116; and the fourth-color-layer 118 are stack-affixed to a flat section of the vehicle tire 102 and in alternate embodiments the first-color-layer 112, the second-color-layer 114, the third-color-layer 116; and the fourth-color-layer 118 are stack-affixed at an angle into a groove section of the vehicle tire 102. Combinations of the above may be used. The first-color-layer 112, the second-color-layer 114, the third-color-layer 116; and the fourth-color-layer 118 are stack-affixed and extend radially outwardly from the vehicle tire 102. The first-color-layer 112, the second-color-layer 114, the third-color-layer 116; and the fourth-color-layer 118 may comprise indicator-shapes 120.

The first-color-layer 112, the second-color-layer 114, the third-color-layer 116; and the fourth-color-layer 118 of the tire longevity measurement system 100 may or may not be included during OEM (original equipment manufacturer) manufacture. The first-color-layer 112, the second-color-layer 114, the third-color-layer 116; and the fourth-color-layer 118 are included in balancing of the vehicle tire 102 so as not to interfere with tire-balance during use and maintenance. The first-color-layer 112, the second-color-layer 114, the third-color-layer 116; and the fourth-color-layer 118 are not included during OEM manufacture in certain embodiments and other embodiments may be retro-fit to the tire 102.

The indicator-shapes 120 of the tire longevity measurement system may comprise pictures; and/or logos, some examples shown for exemplary means. The indicator-shapes 120 may be alpha-numeric and where the alpha-numeric indicator-shapes are used they may comprise functional indicia 130 related to warnings. The indication of wear may also come from the shape. As wear increases the shape changes and they begin to disappear as shown in the exemplary football indicator-shape 120. Upon reading this specification, it should be appreciated that, under appropriate circumstances, considering such issues as user preferences, design preference, structural requirements, marketing preferences, cost, available materials, technological advances, etc., other colors and shapes and combination arrangements such as, for example, squares, circles, triangles, rectangles, polygons, stars, letters, numbers, names, sports items, hearts, flowers, etc., may be sufficient. The different shapes and colors may represent for example (<20,000 miles; 20,000-35,000 miles; 35,000-45,000; and 45,000-49,000 miles). Vehicle tire 102 may comprise shapes around the circumference or in portions of. Symbols may be across the width of vehicle tire 102 so as to show uneven wear of vehicle tire 102. Three stars for example may be engraved into the tread of vehicle tire 102 and may be used to indicate wear of vehicle tire 102 (when star or other shape disappears).

According to one embodiment, the tire longevity measurement system 100 may be arranged as a kit. In particular, the tire longevity measurement system 100 may further include a set of instructions. The instructions may detail functional relationships in relation to the structure of the tire longevity measurement system 100 such that the tire longevity measurement system 100 can be used, maintained, or the like, in a preferred manner.

A method for use of the tire longevity measurement system 100 shown in FIG. 5 may include one or more components or features of the tire longevity measurement system 100 as described above. As illustrated, the method for using the tire longevity measurement system 100 may include the steps of: step one 501 providing the tire longevity measurement system, the system comprising: a plurality of visual-wear-indicators including a first-color-layer; a second-color-layer; a third-color-layer; and a fourth-color-layer (optional); wherein the first-color-layer, the second-color-layer, the third-color-layer; and the fourth-color-layer are stack-affixed to a vehicle tire such that wear in respective sequence is able to be visually noted (or use of a shaped item); step two 502 manufacturing the vehicle tires to include the tire longevity measurement system; step three 503 viewing the vehicle tire to provide a viewer-user with a ready indication of relative tire tread wear; and step four 504 servicing the vehicle tire according to indication provided.

It should be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for manufacture and use of the present invention, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A tire longevity measurement system, the system comprising:
a plurality of layered, different-colored, visual-wear-indicators; and
wherein the indicators are adapted to lie on or within a vehicle tire to sequentially appear as the tire wears.

2. The system of claim 1, wherein at least one of the indicators is adapted to lie circumferentially.

3. The system of claim 2, wherein at least one of the indicators is adapted to lie within a ply of the vehicle tire.

4. The system of claim 2, wherein at least one of the indicators is adapted to not lie within a ply of the vehicle tire.

5. The system of claim 1, wherein at least one of the indicators is adapted to lie on a flat section of the vehicle tire.

6. The system of claim 1, wherein at least one of the indicators is adapted to lie at an angle into a groove section of the vehicle tire.

7. The system of claim 1, wherein at least one of the indicators is adapted to lie extending radially outwardly from the vehicle tire.

8. The system of claim 1, wherein none of the indicators is black.

9. The system of claim 8, wherein the plurality of layered, different-colored visual-wear-indicators comprises two layers of indicators.

10. The system of claim 9, wherein the plurality of layered, different-colored visual-wear-indicators comprises 3-5 layers of indicators.

11. The system of claim 9, wherein at least one of the indicators comprises a geometric shape different from a geometric shape of a different one of the indicators.

12. The system of claim 9, wherein at least one of the indicators comprises a picture different from a picture of a different one of the indicators.

13. The system of claim 9, wherein at least one of the indicators comprises a logo shape.

14. The system of claim 9, wherein at least one of the indicators comprises an alphanumeric shape.

15. The system of claim 14, wherein at least one of the alpha-numeric shapes functionally indicates a degree of wear or a warning.

16. A tire longevity measurement system comprising four layered, different-colored, visual-wear-indicators wherein
the indicators are adapted to lie circumferentially on or within a ply of a flat section of a vehicle tire to sequentially appear as the tire wears,
none of the indicators is black,
and
at least one of the indicators comprises a geometric shape different from a geometric shape of a different one of the indicators to functionally indicate a degree of wear or a warning.

17. The system of claim 16, further comprising a set of instructions wherein the system is arranged as a kit.

18. A method of using a tire longevity measurement system comprising providing the system of claim 1.

19. A method of using a tire longevity measurement system comprising providing the system of claim 10.

20. The method of claim 19 further comprising manufacturing a tire including the system.
